(19) United States
(12) Patent Application Publication
(10) Pub. No.: US 2014/0376151 A1
(43) Pub. Date: Dec. 25, 2014

(54) METHOD OF MANUFACTURING MULTILAYER CERAMIC ELECTRONIC COMPONENT AND MULTILAYER CERAMIC ELECTRONIC COMPONENT MANUFACTURED THEREBY

(71) Applicant: SAMSUNG ELECTRO-MECHANICS CO., LTD., Suwon (KR)

(72) Inventors: Yu Na KIM, Suwon (KR); Jae Yeol CHOI, Suwon (KR); Jong Ho LEE, Suwon (KR); Sung Woo KIM, Suwon (KR)

(73) Assignee: SAMSUNG ELECTRO-MECHANICS CO., LTD., Suwon (KR)

(21) Appl. No.: 14/029,017

(22) Filed: Sep. 17, 2013

(30) Foreign Application Priority Data
Jun. 21, 2013 (KR) 10-2013-0071712

(51) Int. Cl. H01G 4/30

(52) U.S. Cl. CPC H01G 4/30
USPC 361/301.4; 29/25.41

(57) ABSTRACT

There is provided a method of manufacturing a multilayer ceramic electronic component, the method including: preparing a ceramic multilayer body by stacking and sintering ceramic green sheets having internal electrodes formed thereon; determining whether or not a distance d1 from an edge of a side surface of the ceramic multilayer body to the internal electrode exceeds 8.0 μm; and forming a reinforcing layer on the side surface when the distance d1 ranges from 0.1 μm to 8.0 μm.

### CROSS-REFERENCE TO RELATED APPLICATION

This application claims the priority of Korean Patent Application No. 10-2013-0071712 filed on Jun. 21, 2013, with the Korean Intellectual Property Office, the disclosure of which is incorporated herein by reference.

### BACKGROUND OF THE INVENTION

1. Field of the Invention

The present invention relates to a method of manufacturing a multilayer ceramic electronic component and a multilayer ceramic electronic component manufactured thereby having excellent reliability.

2. Description of the Related Art

In accordance with the recent trend for the miniaturization of electronic products in conjunction with the implementation of high performance and the like therein, there is demand for electronic components for use in electronic products which are small in size, have high degrees of capacitance, and the like. In line with this demand for miniaturization and high degrees of capacitance, multilayer ceramic electronic components have drawn attention, and demand therefor has increased accordingly.

In order to implement miniaturization and high degrees of capacitance in such multilayer ceramic electronic components, internal electrodes thereof have been required to be thinned and stacked in increasingly large amounts.

A multilayer ceramic electronic component is generally manufactured by forming internal electrodes on ceramic green sheets and performing stacking, compressing, sintering, and cutting processes thereon.

In accordance with the miniaturization of the multilayer ceramic electronic component, in the case in which a ceramic multilayer body is manufactured by aligning and printing the internal electrodes on the ceramic green sheets, and then performing stacking, compressing, sintering, and cutting processes thereon as described above, the internal electrodes may be positioned towards one side surface of the ceramic multilayer body.

That is, since the internal electrodes are positioned towards one side surface of the ceramic multilayer body, short-circuits between the internal electrodes and other electronic components adjacent thereto may occur or external electrodes having opposite polarities may be electrically connected to thus be short-circuited, such that a defect rate may be increased.

Accordingly, the ceramic multilayer body in which the sideward positioning of the internal electrodes is generated as described above is classified as defective and is discarded during a process of manufacturing the multilayer ceramic electronic component.

Therefore, there is need for a method of improving the reliability of a multilayer ceramic electronic component and increasing a manufacturing yield during the manufacturing process.

Patent document 1 below is directed to a ceramic chip body.

Patent document 1 discloses that an insulation coating layer is formed to protect the ceramic chip body from an external environmental change to achieve reliability, but fails to disclose an element corresponding to a reinforcing layer according to an embodiment of the present invention.

### RELATED ART DOCUMENT

(Patent Document 1) Korean Patent Registration No. KR 10-1185892

### SUMMARY OF THE INVENTION

An aspect of the present invention provides a method of manufacturing a multilayer ceramic electronic component capable of improving reliability and decreasing a defect rate due to short-circuits.

According to an aspect of the present invention, there is provided a method of manufacturing a multilayer ceramic electronic component, the method including: preparing a ceramic multilayer body by stacking and sintering ceramic green sheets having internal electrodes formed thereon; determining whether or not a distance d1 from an edge of a side surface of the ceramic multilayer body to the internal electrode exceeds 8.0 μm; and forming a reinforcing layer on the side surface when the distance d1 ranges from 0.1 μm to 8.0 μm.

The reinforcing layer may be formed to have a thickness d2 of 5 μm to 20 μm.

When a width of the ceramic multilayer body is defined as w, the reinforcing layer may be formed to satisfy the following Equation 1:

0.01<(d1+d2)/(w/2)<0.045 Equation 1

The reinforcing layer may be formed using at least one of a ceramic powder, an epoxy, and an epoxy containing a ceramic powder dispersed therein.

The method may further include forming external electrodes on the ceramic multilayer body having the reinforcing layer formed therein, the external electrodes being electrically connected to the internal electrodes.

According to another aspect of the present invention, there is provided a multilayer ceramic electronic component including: a ceramic multilayer body including dielectric layers having internal electrodes formed thereon; and a reinforcing layer formed on a side surface of the ceramic multilayer body when a distance d1 from an edge of the side surface of the ceramic multilayer body to the internal electrode ranges from 0.1 μm to 8.0 μm.

The reinforcing layer may have a thickness d2 of 5 μm to 20 μm.

When a width of the ceramic multilayer body is defined as w, the following Equation 1 may be satisfied:

0.01<(d1+d2)/(w/2)<0.045 Equation 1

The reinforcing layer may be formed of at least one of a ceramic powder, an epoxy, and an epoxy containing a ceramic powder dispersed therein.

The multilayer ceramic electronic component may further include external electrodes electrically connected to the internal electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart schematically showing a method of manufacturing a multilayer ceramic electronic component according to an embodiment of the present invention;

FIG. 2 is an exploded perspective view schematically showing a ceramic multilayer body according to the embodiment of the present invention;

FIG. 3 is a perspective view schematically showing the ceramic multilayer body according to the embodiment of the present invention;

FIG. 4 is a schematic cross-sectional view taken along line A-A′ of FIG. 3;

FIG. 5 is a perspective view schematically showing the ceramic multilayer body on which a reinforcing layer is formed according to the embodiment of the present invention;

FIG. 6 is a schematic cross-sectional view taken along line B-B′ of FIG. 5; and

FIG. 7 is a schematic perspective view of the multilayer ceramic electronic component in which external electrodes are formed.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same or like reference numerals will be used throughout to designate the same or like elements.

A multilayer ceramic electronic component according to an embodiment of the invention may be appropriately used in a multilayer ceramic capacitor, a multilayer varistor, a thermistor, a piezoelectric element, a multilayer substrate, or the like, having a structure in which ceramic dielectric layers are used and internal electrodes face each other, having the dielectric layer interposed therebetween.

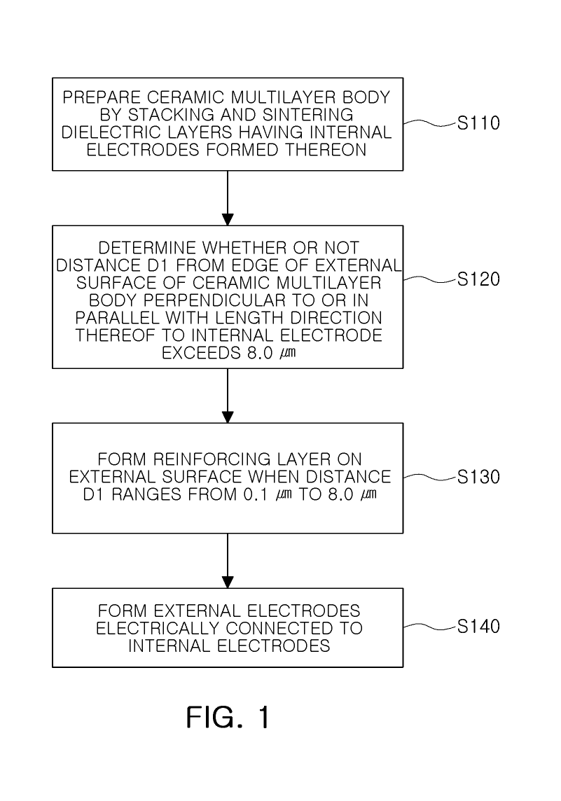

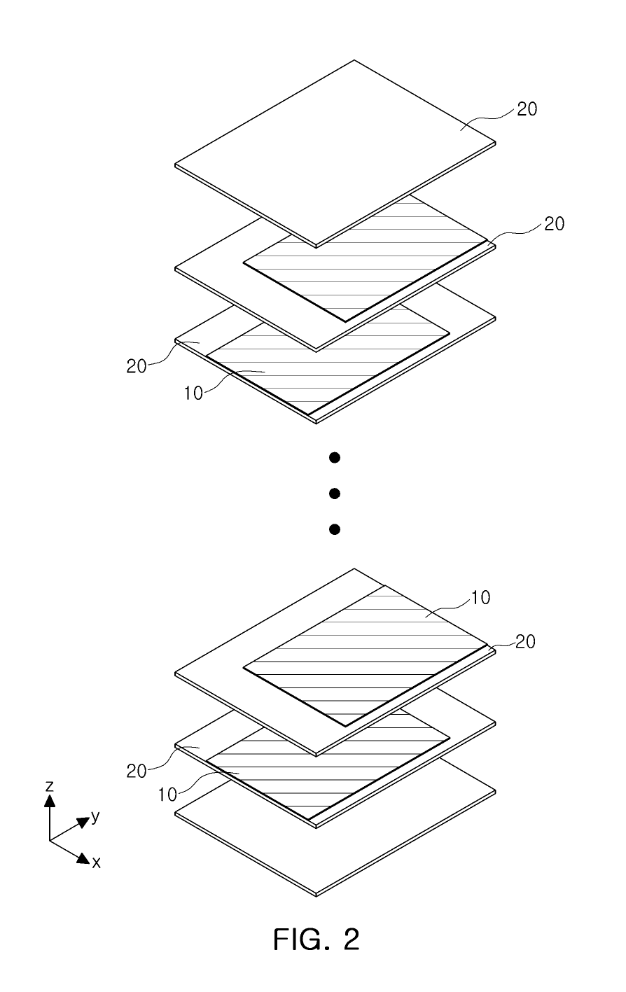

FIG. 1 is a flowchart schematically showing a method of manufacturing a multilayer ceramic electronic component according to an embodiment of the invention, and FIG. 2 is an exploded perspective view schematically showing a ceramic multilayer body according to the embodiment of the invention.

Referring to FIGS. 1 and 2, a method of manufacturing a multilayer ceramic electronic component 100 according to the embodiment of the invention may include preparing a ceramic multilayer body 1 by stacking and sintering ceramic green sheets 20 having internal electrodes 10 formed thereon in operation S110; determining whether or not a distance d1 from an edge of aside surface of the ceramic multilayer body 1 to the internal electrode 10 exceeds 8.0 μm in operation S120; and forming a reinforcing layer on the side surface when the distance d1 ranges from 0.1 μm to 8.0 μm in operation S130.

In the preparing of the ceramic multilayer body 1 (S110), a ceramic powder, a binder and a solvent may be mixed to prepare slurry, and the slurry may be used to form the ceramic green sheets 20 having a thickness of several μm by a doctor blade method.

In addition, the internal electrodes 10 may be formed on the ceramic green sheets 20 using a conductive paste.

The internal electrodes 10 may be formed by using a conductive paste containing a conductive metal powder.

As the conductive metal powder, silver (Ag), lead (Pb), platinum (Pt), nickel (Ni), copper (Cu), or the like, may be used alone or by mixing two or more thereof, but is not particularly limited thereto.

After the internal electrodes 10 are formed, the ceramic green sheets 20 are separated from a carrier film, stacking the plurality of ceramic green sheets 20 in an overlap manner, thereby forming a multilayer body.

Then, compressing, sintering, cutting, and polishing processes may be performed to manufacture the ceramic multilayer body 1.

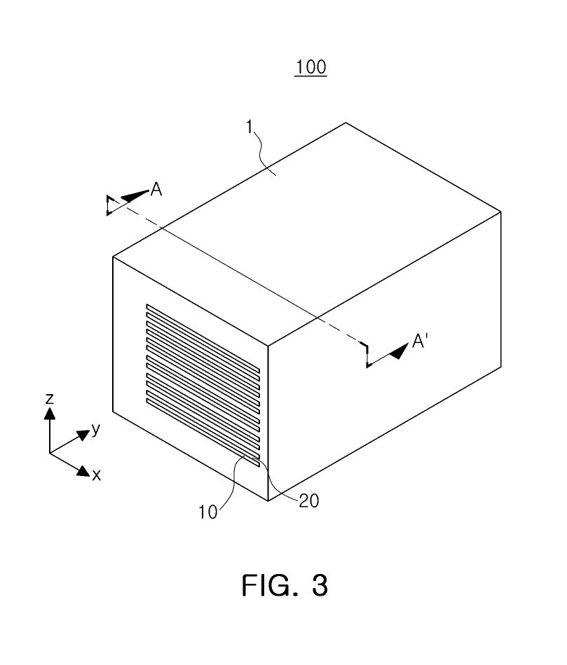

FIG. 3 is a perspective view schematically showing the ceramic multilayer body 1 manufactured as described above.

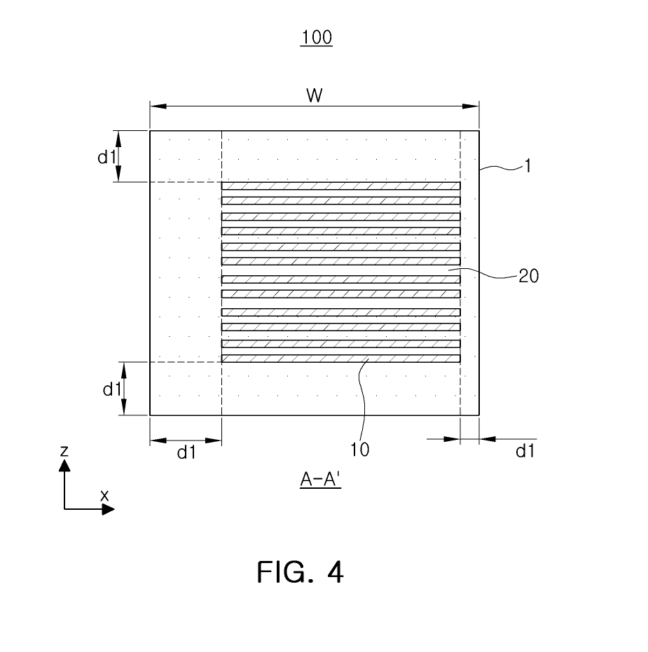

FIG. 3 is a perspective view schematically showing the ceramic multilayer body according to the embodiment of the present invention; and FIG. 4 is a schematic cross-sectional view taken along line A-A′ of FIG. 3.

Then, referring to FIG. 3, the determining operation S120 as to whether or not the distance d1 from the edge of the side surface of the ceramic multilayer body 1 to the internal electrode 10 exceeds 8.0 μm will be specifically described.

In general, the ceramic multilayer body 1 may be cut such that the dielectric layer 20 remains uniform on both sides of the internal electrode.

A portion formed by the remaining dielectric layer 20 is referred to as a margin part.

The margin part is required for preventing a short-circuit caused by the internal electrode 10 being exposed outwardly from being generated, and for securing reliability of the multilayer ceramic electronic component.

In particular, in order to manufacture the multilayer ceramic electronic component, the ceramic green sheets 20 having the internal electrode 10 printed thereon are stacked, compressed, and sintered. At the time of sintering, cracks may be generated due to a difference in thermal expansion coefficients between the internal electrodes and the ceramic green sheets.

In the case in which the cracks are generated, when the margin part is not sufficiently thick, the internal electrode 10 is exposed outwardly, so that the short-circuit may be generated and the reliability of the multilayer ceramic electronic component may be decreased.

In FIG. 3, when a surface formed in a stacking direction z and a width direction x is defined as a side surface of the ceramic multilayer body 1, a distance from the edge of the side surface to the internal electrode 10 is referred to as d1.

That is, in the case in which d1 is less than 8 μm, an effect of the margin part for preventing short-circuits is remarkably deteriorated, resulting in a reduction in the reliability of the multilayer ceramic electronic component.

Therefore, it is necessary to determine whether or not the distance d1 exceeds 8 μm after the ceramic multilayer body 1 is manufactured.

The method of determining whether or not the distance d1 exceeds 8 μm may be performed with the naked eye, or in a manner such that a marked region is formed before the ceramic green sheets 20 are stacked, and any method may be used so long as the distance d1 can be determined, without being limited to the above-mentioned methods.

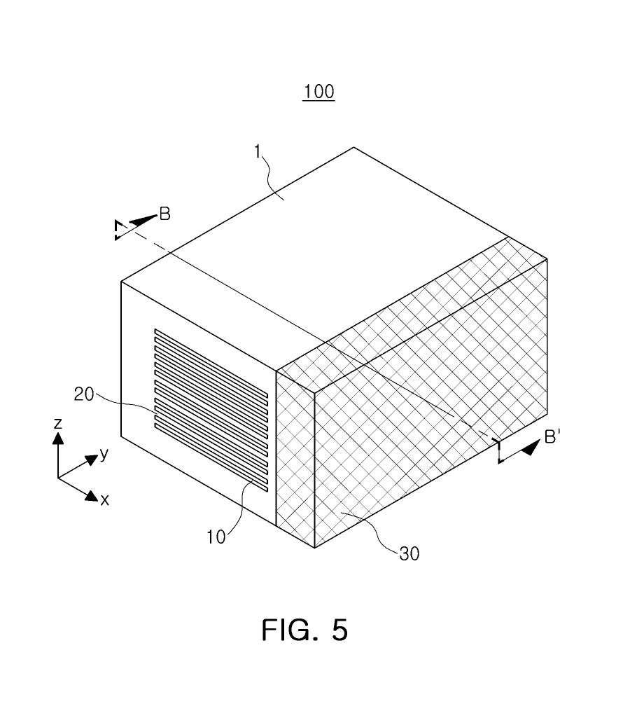

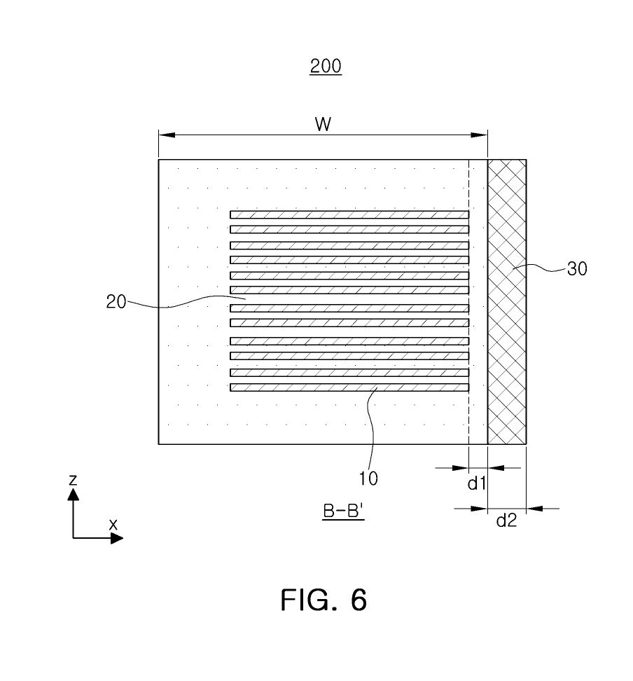

FIG. 5 is a perspective view schematically showing the ceramic multilayer body 1 on which a reinforcing layer 30 is formed according to the embodiment of the present invention; and FIG. 6 is a schematic cross-sectional view taken along line B-B′ of FIG. 5.

Hereinafter, referring to FIGS. 5 and 6, the forming of the reinforcing layer 30 on the side surface in operation S130 when the distance d1 ranges from 0.1 μm to 8.0 μm will be described in detail.

The reinforcing layer 30 may be formed using at least one of a ceramic powder, an epoxy, and an epoxy containing a ceramic powder dispersed therein.

The ceramic powder which is the same as the ceramic powder used in the forming of the ceramic green sheet 20 is dispersed in the epoxy, such that the reinforcing layer 30 and the ceramic multilayer body 1 may be easily combined with each other.

The following Table 1 shows respective short-circuit rates (%), respective reliabilities of 100 samples, and respective size defects (%) of chips in which a plating process has been completed with respect to 100 multilayer ceramic electronic components, each being manufactured to have the reinforcing layer 30 when a width w of the ceramic multilayer body 1 ranges from 1127 μm to 1131 μm.

TABLE 1

| | | | | | | Short- | | Defect |
|---|---|---|---|---|---|---|---|---|
| | | | d1 + d2 | | (a + b)/( | Circuit | | Rate in |
| Sample | d1 (μm) | d2 (μm) | (μm) | w (μm) | w/2) | Rate (%) | Reliability | Size (%) |
| 1* | 1 | 0 | 1 | 1131 | 0.00177 | 100 | NG | 0 |
| 2* | 1 | 2 | 3 | 1127 | 0.00532 | 57 | NG | 0 |
| 3 | 1 | 5 | 6 | 1133 | 0.01059 | 6 | OK | 0 |
| 4 | 1 | 7 | 8 | 1132 | 0.01413 | 4 | OK | 0 |
| 5 | 1 | 10 | 11 | 1130 | 0.01947 | 0 | OK | 0 |
| 6 | 1 | 15 | 16 | 1131 | 0.02829 | 0 | OK | 0 |
| 7 | 1 | 17 | 18 | 1131 | 0.03183 | 0 | OK | 0 |
| 8 | 1 | 20 | 21 | 1132 | 0.03710 | 0 | OK | 0 |
| 9 | 5 | 20 | 25 | 1129 | 0.04429 | 0 | OK | 0 |
| 10* | 1 | 35 | 26 | 1130 | 0.04602 | 0 | OK | 24 |
| 11* | 1 | 30 | 31 | 1131 | 0.05482 | 0 | OK | 33 |
| 12* | 1 | 35 | 36 | 1131 | 0.06366 | 0 | OK | 51 |

*: Comparative Example

Each test in Table 1 was performed under conditions of a temperature of 85° C. a relative humidity of 85% RH, and 1.0 Vr.

The short-circuit rate was obtained by measuring the number of samples in which short-circuits were generated out of 100 samples.

In terms of reliability, a case in which one or more samples out of 100 samples were measured to have less than 1E+4 ohm was represented as “NG,” and a case in which no sample having less than 1E+4 ohm was found was represented as “OK.”

The defect rate in size was obtained by measuring the number of samples out of 100 samples which were outside of a desired range of size.

It may be appreciated from Table 1 that when d1 was 1 μm, the thickness d2 of the reinforcing layer 30 was 5 μm to 20 μm.

When the thickness d2 of the reinforcing layer 30 was 5 μm to 20 μm, the short-circuit rate was less than 10%, whereby the defect rates of the multilayer ceramic electronic components were decreased.

In particular, it may be appreciated that there was no sample having less than 1E+4 ohm out of 100 samples.

In other words, it may be appreciated that when the thickness d2 of the reinforcing layer 30 was less than 5 μm, the short-circuit rate was rapidly increased to 5%.

In addition, it may be appreciated that in the case in which the thickness d2 of the reinforcing layer 30 was less than 5 μm, one or more samples having less than 1E+4 ohm out of 100 samples were found, whereby the reliability thereof was rapidly decreased.

It may be appreciated that in the case in which the thickness d2 of the reinforcing layer 30 was more than 20 μm, the defect rate in terms of size of the complete multilayer ceramic electronic component was rapidly increased.

That is, in the case in which the thickness of the reinforcing layer 30 was 25 μm (Sample No. 10), the defect in size was generated in 24 samples out of 100 samples.

Therefore, it may be appreciated that in the case in which the thickness of the reinforcing layer 30 was 5 μm to 20 μm, a multilayer ceramic electronic component was manufactured to have no short-circuit defect, improved reliability, and an appropriate size.

Referring to Table 1, the thickness d2 of the reinforcing layer 30 may satisfy the following Equation 1:

0.01<(d1+d2)/(w/2)<0.045 Equation 1

When the thickness d2 of the reinforcing layer 30 satisfies Equation 1, the short-circuit rate is less than 10%, thereby decreasing the defect rate of the multilayer ceramic electronic component.

In particular, it may be appreciated that there was no sample having less than 1E+4 ohm out of 100 samples.

In other words, it may be appreciated that when the thickness d2 of the reinforcing layer 30 satisfies Equation 1, the short-circuit rate is rapidly increased to 5%.

In other words, it may be appreciated that when (d1+d2)/(w/2) is less than 0.01, the short-circuit rate is rapidly increased to 5%.

In addition, it may be appreciated that in the case in which (d1+d2)/(w/2) is less than 0.01 μm, one or more samples having less than 1E+4 ohm out of 100 samples may be found, such that reliability is rapidly decreased.

It may be appreciated that in the case in which (d1+d2)/(w/2) is more than 0.045 μm, the defect rate in size of the complete multilayer ceramic electronic component is rapidly increased.

That is, in the case in which (d1+d2)/(w/2) is 0.04602 μm (Sample No. 10), the defect in size is generated in 24 samples out of 100 samples.

Therefore, it may be appreciated that in the case in which the thickness d2 of the reinforcing layer 30 satisfies Equation 1, a multilayer ceramic electronic component is manufactured to have no short-circuit defect, improved reliability, and an appropriate size.

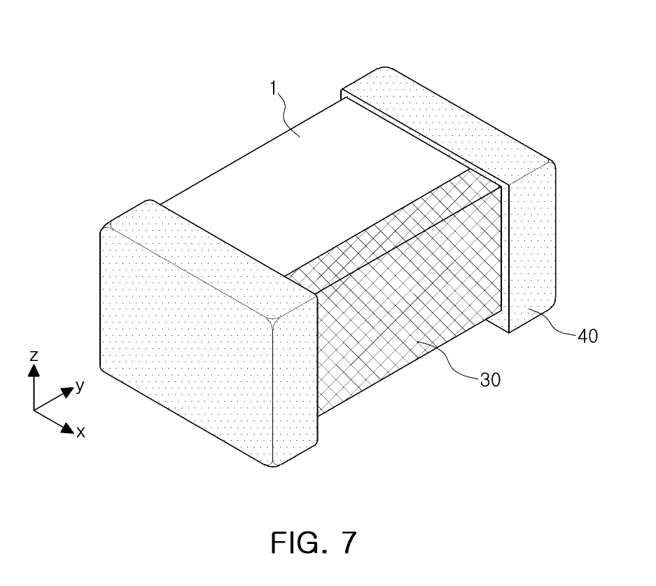

FIG. 7 is a schematic perspective view of a multilayer ceramic electronic component in which external electrodes are formed.

A multilayer ceramic electronic component 200 according to the embodiment of the invention may include a ceramic multilayer body 1 having internal electrodes 10 formed therein and including dielectric layers 20; and a reinforcing layer 30 formed on a side surface of the ceramic multilayer body 1, wherein a distance d1 from an edge of the side surface of the ceramic multilayer body to the internal electrode 10 ranges from 0.1 μm to 8.0 μm.

External electrodes 40 electrically connected to the internal electrodes 10 may be formed on both end surfaces of the ceramic multilayer body 1 in a length direction (y direction) thereof.

As set forth above, according to embodiments of the invention, the reinforcing layer is formed on the side surface of the ceramic multilayer body when the distance d1 from the edge of the side surface to the internal electrode of the multilayer ceramic electronic component ranges from 0.1 μm to 8.0 μm, thereby preventing the internal electrode from being exposed outwardly of the side surface of the ceramic multilayer body to thereby be short-circuited with other electronic components adjacent to the internal electrodes.

The short-circuits may be prevented, whereby the multilayer ceramic electronic component may have excellent reliability.

In addition, in the case of a product in which internal electrodes are positioned towards one side surface of the ceramic multilayer body and thus cannot be appropriately used, the reinforcing layer is further formed on the product, thereby improving a manufacturing yield in the process of manufacturing the multilayer ceramic electronic component.

While the present invention has been shown and described in connection with the embodiments, it will be apparent to those skilled in the art that modifications and variations can be made without departing from the spirit and scope of the invention as defined by the appended claims.

What is claimed is:

1. A method of manufacturing a multilayer ceramic electronic component, the method comprising:
preparing a ceramic multilayer body by stacking and sintering ceramic green sheets having internal electrodes formed thereon;
determining whether or not a distance d1 from an edge of a side surface of the ceramic multilayer body to the internal electrode exceeds 8.0 μm; and
forming a reinforcing layer on the side surface when the distance d1 ranges from 0.1 μm to 8.0 μm.

2. The method of claim 1, wherein the reinforcing layer is formed to have a thickness d2 of 5 μm to 20 μm.

3. The method of claim 2, wherein when a width of the ceramic multilayer body is defined as w, the reinforcing layer is formed to satisfy the following Equation 1:
0.01<(d1+d2)/(w/2)<0.045 Equation 1.

4. The method of claim 1, wherein the reinforcing layer is formed using at least one of a ceramic powder, an epoxy, and an epoxy containing a ceramic powder dispersed therein.

5. The method of claim 1, further comprising forming external electrodes on the ceramic multilayer body having the reinforcing layer formed therein, the external electrodes being electrically connected to the internal electrodes.

6. A multilayer ceramic electronic component comprising:
a ceramic multilayer body including dielectric layers having internal electrodes formed thereon; and
a reinforcing layer formed on a side surface of the ceramic multilayer body when a distance d1 from an edge of the side surface of the ceramic multilayer body to the internal electrode ranges from 0.1 μm to 8.0 μm.

7. The multilayer ceramic electronic component of claim 6, wherein the reinforcing layer has a thickness d2 of 5 μm to 20 μm.

8. The multilayer ceramic electronic component of claim 7, wherein when a width of the ceramic multilayer body is defined as w, the following Equation 1 is satisfied:
0.01<(d1+d2)/(w/2)<0.045 Equation 1.

9. The multilayer ceramic electronic component of claim 6, wherein the reinforcing layer is formed of at least one of a ceramic powder, an epoxy, and an epoxy containing a ceramic powder dispersed therein.

10. The multilayer ceramic electronic component of claim 6, further comprising external electrodes electrically connected to the internal electrodes.
